(19) United States
(12) Patent Application Publication
(10) Pub. No.: US 2026/0320626 A1
(43) Pub. Date: Oct. 15, 2026

(54) SERVICE PROVISION APPARATUS

(71) Applicant: NTT DOCOMO, INC., Tokyo (JP)

(72) Inventors: Tooru MATSUNAGA, Chiyoda-ku (JP); Jun OONISHI, Chiyoda-ku (JP)

(73) Assignee: NTT DOCOMO, INC., Tokyo (JP)

(21) Appl. No.: 19/484,383

(22) PCT Filed: Jun. 27, 2024
(86) PCT No.: PCT/JP2024/023424

§ 371 Date: Nov. 14, 2025

(30) Foreign Application Priority Data
Aug. 2, 2023 (JP) 2023-126102

(51) Int. Cl. G06Q 30/015; G06Q 30/0203; G06Q 30/0217; H04N 7/15

(52) U.S. Cl. CPC G06Q 30/015; G06Q 30/0203; G06Q 30/0217; H04N 7/157

(57) ABSTRACT

A first receiver receives from a first user a complaint or a request regarding a service. A classifier classifies the complaint or the request received by the first receiver, to output one or more items related to an improvement to the service. A second receiver receives from a second user a vote for determining whether an improvement is required for a part or all of the one or more items. A calculator calculates a vote count score for each of the one or more items by multiplying the vote by a coefficient corresponding to points held by the second user. A presenter presents the vote count score for each of the one or more items calculated by the calculator, to at least one of the administrator of the service or users using the service. A point allocator grants points to the first user in a case in which a remedy for an improvement has been implemented on the one or more items corresponding to the complaint or the request received from the first user.

### TECHNICAL FIELD

The present invention relates to service provision apparatuses.

### BACKGROUND ART

Techniques of collecting complaints or requests from users and presenting solutions to the complaints or requests have conventionally been developed. For example, in a case in which there is a user who has posted a comment denying a problem or a complaint, a data processing apparatus disclosed in Patent Document 1 described below automatically extracts a countermeasure from the comment through a part-of-speech analysis or a similar analysis, to present to a user having posted a problem or complaint with the extracted countermeasure.

### RELATED ART DOCUMENT

### Patent Document

Patent Document 1: Japanese Patent Application Laid-Open Publication No. 2011-48524

### SUMMARY OF THE INVENTION

### Problem to be Solved by the Invention

Examples of complaints or requests from users include complaints or requests regarding a service used by the users. Generally, a remedy for a complaint or request regarding a service, in other words, a remedy related to an improvement to the service, is implemented in a one-way manner from the administrator of the service to the users. Therefore, the users cannot be actively involved in an improvement of the service.

An object of the present invention is to enable users to be easily involved in an improvement of a service.

### Means of Solving the Problems

A service provision apparatus according to one aspect of the present invention includes: a first receiver configured to receive from a first user a complaint or a request regarding a service; a classifier configured to classify the complaint or the request received by the first receiver, to output one or more items related to an improvement to the service; a second receiver configured to receive from a second user a vote for determining whether an improvement is required for a part or all of the one or more items; a calculator configured to calculate a vote count score for each of the one or more items by multiplying the vote by a coefficient corresponding to points held by the second user, a presenter configured to present the vote count score for each of the one or more items calculated by the calculator, to at least one of an administrator of the service or users using the service; and a point allocator configured to grant points to the first user in a case in which a remedy for an improvement has been implemented on the one or more items corresponding to the complaint or the request received from the first user.

Effect of the Invention According to one aspect of the present invention, it is possible to enable users to be easily involved in improvement of a service.

### BRIEF DESCRIPTION OF THE DRAWINGS

FIG. 1 is a block diagram illustrating a configuration of a system 1 according to an embodiment.

FIG. 2 is a block diagram illustrating a configuration of a user terminal 20.

FIG. 3 is a block diagram illustrating a configuration of a server 10.

FIG. 4 is a diagram schematically illustrating a complaint room arranged in a virtual space VS.

FIG. 5 is a flowchart illustrating an operation of a processing apparatus 103.

FIG. 6 is a block diagram illustrating a configuration of a server 10 according to a first modification.

FIG. 7 is a block diagram illustrating a configuration of a server 10 according to a second modification.

### MODES FOR CARRYING OUT THE INVENTION

### A. First Embodiment

### A-1. System Configuration

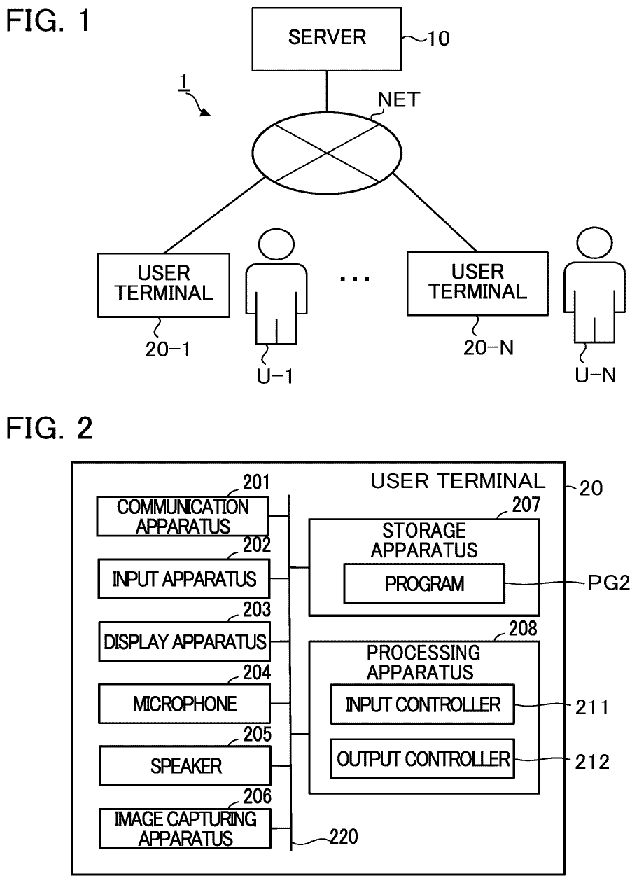

FIG. 1 is a block diagram illustrating a configuration of a system 1 according to an embodiment. The system 1 includes a server 10 and user terminals 20-1 to 20-n (N is a natural number equal to or greater than 2). The server 10 and the user terminals 20-1 to 20-N are connected via a network NET.

The user terminal 20-1 is carried by a user U-1. Similarly, a user terminal 20-k is carried by a user U-k (k is a natural number between 2 and N). Hereinafter, in a case in which the user terminals 20-1 to 20-N are not distinguished from each other, they are referred to simply as “user terminal 20”. In a case in which the users U-1-1 to U-N are not distinguished from each other, they are referred to simply as “user U”.

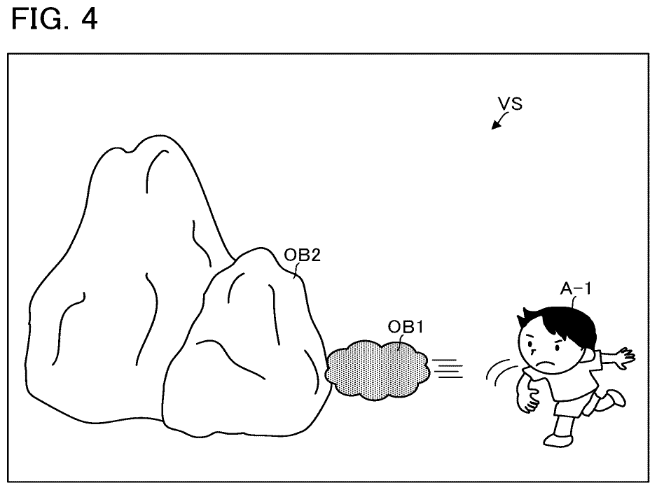

The system 1 causes a user terminal 20 to display a virtual space VS (see FIG. 4) to enable a user U to have various experiences in the virtual space VS. Each user U acts as an avatar A in the virtual space VS. An avatar A corresponding to the user U-1 is an avatar A-1. Similarly, an avatar A corresponding to the user U-k is an avatar A-k. In a case in which the avatars A-1 to A-N are not distinguished from each other, they are referred to simply as “avatar A”.

For example, an image (hereinafter, referred to as “virtual space image”) of the virtual space VS displayed on the user terminal 20-1 indicates a field of view of the avatar A-1 corresponding to the user U-1. A point of view of the virtual space image may be arranged near the avatar A-1 to cause the avatar A-1 to be displayed in the virtual space image. The user U-1 can move in the virtual space VS or establish a communication including a conversation with another user U-k by operating the avatar A-1 using the user terminal 20-1.

The server 10 is one example of a service provision apparatus that provides a service. The service in the present embodiment is a virtual space access service that provides an access to the virtual space VS using the user terminals 20-1 to 20-N.

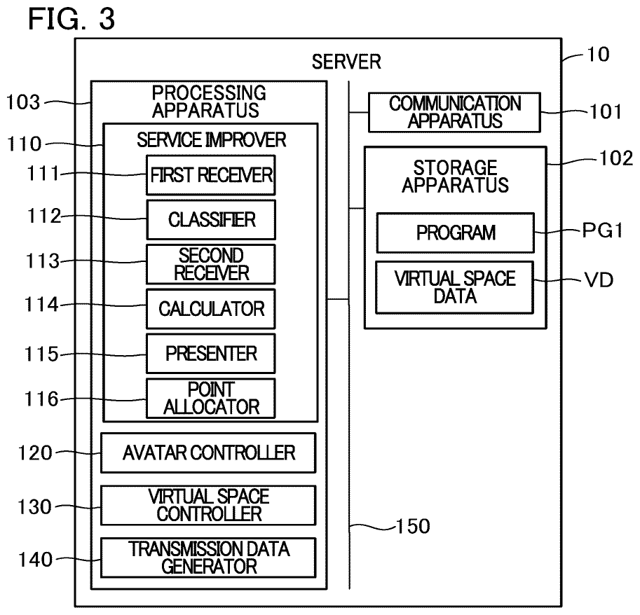

The server 10 manages the virtual space VS. More specifically, the server 10 manages virtual space data VD (see FIG. 3) for causing the user terminals 20 to display the virtual space VS. The server 10 generates display data for displaying a virtual space image on each user terminal 20 on the basis of the virtual space data VD and transmits the display data to each user terminal 20.

The user terminals 20 are, for example, information processing terminals such as a smartphone, a tablet terminal, a personal computer, or a head-mounted display.

### A-2. User Terminal 20

FIG. 2 is a block diagram illustrating a configuration of the user terminals 20. Each of the user terminals 20 includes a communication apparatus 201, an input apparatus 202, a display apparatus 203, a microphone 204, a speaker 205, an image capturing apparatus 206, a storage apparatus 207, a processing apparatus 208, and a bus 220 that connects these apparatuses to each other.

The communication apparatus 201 communicates with the server 10 using a wireless communication or a wired communication. In the present embodiment, the communication apparatus 201 includes an interface connectable to the network NET and communicates with a communication apparatus 101 (see FIG. 3) of the server 10 via the network net.

The input apparatus 202 is an input device (for example, a keyboard, a mouse, a switch, a button, or a sensor) that receives an input from the outside. The display apparatus 203 is a display device (for example, various kinds of display panels such as a liquid-crystal display panel or an organic EL display panel) that displays information to the outside. The display apparatus 203 and the input apparatus 202 may be an integrated component (for example, a touch screen).

In a case in which the user terminal 20 is a head-mounted display, a projection apparatus that projects an image onto a lens arranged in front of the eyes of the user U is provided instead of the display apparatus 203.

The microphone 204 collects speech produced around the user terminal 20 and outputs speech data. In the present embodiment, speech collected by the microphone 204 is mainly speech uttered by the user U. The speaker 205 outputs sounds that are audible near the user terminal 20 on the basis of input speech data. In the present embodiment, sounds output from the speaker 205 are mainly speech uttered by other users U.

The image capturing apparatus 206 generates an image (hereinafter, referred to as “user image”) obtained by capturing an image of the user U. In a case in which the user terminal 20 is a smartphone, a tablet terminal, or a personal computer, the image capturing apparatus 206 is, for example, a front camera that has an image capturing direction oriented to the user U. In a case in which the user terminal 20 is a head-mounted display, the image capturing apparatus 206 is, for example, a gaze-tracking camera.

The storage apparatus 207 is a recording medium readable by the processing apparatus 208. The storage apparatus 207 includes, for example, a nonvolatile memory and a volatile memory. The nonvolatile memory is, for example, a ROM (Read Only Memory), an EPROM (Erasable Programmable Read Only Memory), or an EEPROM (Electrically Erasable Programmable Read Only Memory). The volatile memory is, for example, a RAM (Random Access Memory). The storage apparatus 207 stores therein a program PG2. The program PG2 is a program for causing the user terminal 20 to operate.

The processing apparatus 208 includes one or more CPUs (Central Processing Units). The one or more CPUs are examples of one or more processors. Each of the processors and each of the CPUs is one example of a computer.

The processing apparatus 208 reads the program PG2 from the storage apparatus 207. The processing apparatus 208 executes the program PG2 to function as an input controller 211 and an output controller 212. At least some of these functions may be implemented by circuitry, such as a DSP (Digital Signal Processor), an ASIC (Application Specific Integrated Circuit), a PLD (Programmable Logic Device), and an FPGA (Field Programmable Gate Array).

The input controller 211 transmits input information, which is input from the input apparatus 202, to the server 10. The input information is, for example, information designating a moving direction of the avatar A in the virtual space VS, speech uttered by the user U, or a captured image obtained by capturing an image of the user U.

The output controller 212 outputs output information, which is transmitted from the server 10, from the display apparatus 203. The output information is, for example, a virtual space image or speech uttered by other users U.

### A-3. Server 10

FIG. 3 is a block diagram illustrating a configuration of the server 10. The server 10 includes a communication apparatus 101, a storage apparatus 102, a processing apparatus 103, and a bus 150 that connects these apparatuses to each other.

The communication apparatus 101 communicates with the user terminals 20 using a wireless communication or a wired communication. In the present embodiment, the communication apparatus 101 includes an interface connectable to the network NET and communicates with the communication apparatus 201 (see FIG. 2) of each of the user terminals 20 via the network NET.

The storage apparatus 102 is a recording medium readable by the processing apparatus 103. The storage apparatus 102 includes, for example, a non-volatile memory and a volatile memory. The non-volatile memory is, for example, a ROM, an EPROM, or an EEPROM. The volatile memory is, for example, a RAM. The storage apparatus 102 stores therein a program PG1 and the virtual space data VD.

The program PG1 is a program for causing the server 10 to operate. The virtual space data VD is data for displaying the virtual space VS on each of the user terminals 20. The virtual space data VD includes, for example, information indicating the shape and appearance of each object arranged in the virtual space VS, information indicating the position of each object, and information indicating the shape and appearance of the avatar A corresponding to each user U.

The processing apparatus 103 includes one or more CPUs. The one or more CPUs are examples of one or more processors. Each of the processors and each of the CPUs is one example of a computer.

The processing apparatus 103 reads the program PG1 from the storage apparatus 102. The processing apparatus 103 executes the program PG1 to function as a service improver 110, an avatar controller 120, a virtual space controller 130, and a transmission data generator 140. The service improver 110 includes a first receiver 111, a classifier 112, a second receiver 113, a calculator 114, a presenter 115, and a point allocator 116.

At least part of these functions may be implemented by circuitry, such as a DSP, an ASIC, a PLD, and an FPGA.

### A-4. Details of Processing Apparatus 103

The service improver 110 (the first receiver 111, the classifier 112, the second receiver 113, the calculator 114, the presenter 115, and the point allocator 116), the avatar controller 120, the virtual space controller 130, and the transmission data generator 140 realized by the processing apparatus 103 are described next.

The service improver 110 improves the virtual space access service on the basis of complaints or requests expressed by the users U-1 to U-N using the service. The details of the service improver 110 will be described later.

The avatar controller 120 controls the behaviors of the avatars A in the virtual space VS. Taking the user terminal 20-1 as an example, the avatar controller 120 determines the position of the avatar A-1 in the virtual space VS on the basis of information transmitted from the user terminal 20-1 and designating the moving direction of the avatar A-1 in the virtual space VS. The avatar controller 120 determines a facial expression of the avatar A-1 on the basis of a captured image (a facial expression of the user U-1) transmitted from the user terminal 20-1. The avatar controller 120 controls utterances of the avatar A-1 on the basis of speech uttered by the user U-1 transmitted from the user terminal 20-1. While utterances of the avatar A-1 are basically utterances of the user U-1 themselves, data of the utterance voices may be, for example, processed by a voice changer. The avatar controller 120 determines motions of the mouth of the avatar A-1 on the basis of the speech uttered by the user U-1 transmitted from the user terminal 20-1.

The virtual space controller 130 controls the virtual space VS. Controlling the virtual space VS includes causing the behavior of an avatar A determined by the avatar controller 120 to be reflected in the virtual space data VD. Controlling the virtual space VS also includes, for example, causing changes in the virtual space VS that have taken place due to the behavior of the avatar A to be reflected in the virtual space data VD.

The transmission data generator 140 generates transmission data to be transmitted to the user terminals 20-1 to 20-N. The transmission data is individually generated for each of the user terminals 20-1 to 20-N and is transmitted to the corresponding one of the user terminals 20-1 to 20-N. The virtual space data VD mainly includes image data and speech data. The image data is data for causing the display apparatus 203 of each user terminal 20 to display a virtual space image. The speech data is data for causing the speaker 205 of each user terminal 20 to output sounds in the virtual space VS.

The details of the service improver 110 are described next. The first receiver 111 receives from the user U-1 a complaint or a request (hereinafter, referred to as “complaint or the like”) regarding the virtual space access service. The user U-1 is one example of a first user. In other words, the first receiver 111 receives a complaint or the like regarding the virtual space access service from at least one user U among the users U-1 to U-N. The first receiver 111 may receive a complaint or the like consciously expressed by the user U-1 or may receive a complaint or the like subconsciously expressed by the user U-1.

One example of a way in which the user U-1 consciously expresses a complaint or the like is posting on a bulletin board, a chatbot, or the like. The bulletin board or the chatbot may be installed, for example, by the operating body of the virtual space access service to improve the service. Complaints or the like regarding the virtual space access service may be extracted from posts on general bulletin boards.

One example of another way by which the user U-1 consciously expresses a complaint or the like is a “complaint room”. A complaint room is arranged in the virtual space VS. In the complaint room, the user U-1 throws a first virtual object OB1 corresponding to the user's complaint at a second virtual object OB2 placed in the complaint room.

FIG. 4 is a diagram schematically illustrating a complaint room arranged in the virtual space VS. In FIG. 4, an example is given of a case in which the avatar A-1 corresponding to the user U-1 visits the complaint room. In response to the utterance by the user U-1 in a state in which the avatar A-1 visits the complaint room, the first virtual object OB1 is generated based on the utterance. It is assumed that the contents of the utterances are a complaint or the like regarding the virtual space access service. The first virtual object OB1 may be generated by inputting a text by the user U-1 without any utterance. For example, a text indicating the contents of the utterance may be displayed on the surface of the first virtual object OB1. Alternatively, the contents of the utterance may be output as speech in response to an action such as tapping of the first virtual object OB1. In the example illustrated in FIG. 4, the first virtual object OB1 has the shape of a cloud.

The second virtual object OB2 is arranged in the complaint room. In the example illustrated in FIG. 4, the second virtual object OB2 is a rock. The second virtual object OB2 may be fixed at a position in the complaint room or may be movable.

The user U-1 (the avatar A-1) throws the first virtual object OB1 at the second virtual object OB2. In response to the first virtual object OBI hitting the second virtual object OB2, a change is produced in the first virtual object OB1. As an example, the first virtual object OB1 breaks up and disappears. The change in the first virtual object OB1 may be, for example, shrinking or burning of the first virtual object OB1. For example, in a case in which the complaint of the user U-1 includes a novel content that has never been expressed, visual effects such as changing of the appearance of the second virtual object OB2 hit by the first virtual object OBI may be performed.

The user U-1 can express a complaint or the like externally, by generating the first virtual object OB1 representing the complaint or the like and throwing the first virtual object OB1, without taking the complaint or the like all on the user. Furthermore, an effect is expected in which a change in the first virtual object OB1 caused by the throwing reduces psychological burden on the user U-1 associated with the complaint or the like.

The first receiver 111 receives the contents of the utterance thrown in the form of the first virtual object OB1 in the complaint room from the user U-1 as a complaint or the like. That is, the first receiver 111 receives a complaint or the like based on an operation, which is performed on the first virtual object OB1 corresponding to a complaint or the like and performed by the user U-1 who has accessed the virtual space VS.

The way of expressing a complaint in the complaint room is not limited to those described above. For example, the user U-1 may express a complaint by breaking the first virtual object OB1 or sending the first virtual object OB1 to a place that is out of sight of the user U-1, such as the bottom of the sea or outer space.

The situation in which the user U-1 subconsciously expresses a complaint or the like indicates, for example, that a complaint or the like regarding the virtual space access service is included in the user U-1 talking to himself or herself or a conversation (such as online chat) with other users U. For example, the first receiver 111 analyzes utterances of the user U-1 using the virtual space access service, and when a complaint or the like regarding the virtual space access service is included therein, receives the contents of the compliant or the like. Analyzing utterances of the user U-1 is, for example, keyword detection processing or language recognition processing. Utterances may be remarks in text instead of spoken remarks.

The situation in which the user U-1 subconsciously expresses a complaint or the like also indicates, for example, that an action showing a complaint or the like is performed during use of the virtual space access service. Examples of an action showing a complaint or the like are sighing, throwing the user terminal 20 at a nearby site, repeating an aggressive emote or action, and giving a look showing anger or displeasure. The first receiver 111 detects sighing, for example, as part of the analysis of utterances of the user U-1 described above. The first receiver 111 acquires, for example, a detection value of an acceleration sensor (not illustrated) installed in the user terminal 20 and detects throwing of the user terminal 20 by the user U-1. The first receiver 111 detects, for example, repeating of an aggressive emote or action, based on an operation performed on the user terminal 20 by the user U-1. The first receiver 111 analyzes, for example, the look of the user U-1 using a user image captured by the image capturing apparatus 206 of the user terminal 20.

The actions showing a complaint or the like described above do not show in a direct manner regarding what the user U-1 has a complaint or the like about, as opposed to remarks showing a complaint or the like. The first receiver 111 estimates what the user U-1 has a complaint or the like about, for example, on the basis of a situation of the avatar A-1 at a time when the user U-1 has performed an action showing a complaint or the like.

The first receiver 111 may receive an idea for a remedy (hereinafter, referred to as “remedy idea”) for addressing a complaint or the like, together with the complaint or the like. When extracting a complaint or the like from utterances or posts of the users U, the first receiver 111 detects whether a remedy idea for the complaint or the like is included therein. In a case in which a remedy idea is included, the first receiver 111 records the remedy idea to be associated with the complaint or the like.

The classifier 112 classifies a complaint or the like received by the first receiver 111 to output one or more items related to an improvement of the service. Complaints or the like received by the first receiver 111 are so-called “novel speech from the users U”. There is a case in which these complaints include a common problem that is expressed in a different manner depending on a user U. For example, a complaint of the user U-1 who “cannot find a community suitable for the user” and a complaint of a user U-3 who “feels tired when joining a community” both suggest the possibility of a common problem in an “algorithm for matching personal elements such as taste or character of a user U with a community” although the contents of the remarks are not the same.

As one or more items, various other contents such as “the processing speed of the server 10,” “the communication rate in the network NET,” “the design of the virtual space,” or “manners of the users U using the virtual space” can be output, for example.

The classifier 112 classifies the complaint or the like received from the user U, for example, using AI (Artificial Intelligence) to be sorted into one or more items (issues). Examples of the items are “the processing speed of the server 10,” “the design of the virtual space,” and “manners of the users U”.

The classifier 112 may calculate, for example, importance of each item. The importance of each item is, for example, higher when the number of users U that have expressed complaints or the like as sources of the item is greater. The classifier 112 may, for example, set importance of an item based on a complaint or the like expressed in a case in which there are multiple people, to be higher than importance of an item based on a complaint or the like (talking to one's self) expressed in a case in which the user U is alone.

The classifier 112 may acquire a remedy idea for improving each item, for example, from an AI engine such as ChatGPT. The classifier 112 stores a remedy idea received by the first receiver 111 together with a complaint or the like, in association with an item corresponding to the complaint.

The second receiver 113 receives a vote from the user U-2 to determine whether an improvement is required for a part or all of one or more items output by the classifier 112. The user U-2 is one example of a second user. The user U-2 is also one example of one of the users U-1 to U-N using the virtual space access service. The user U-1 may participate in voting as well as the user U-2.

The second receiver 113 presents a list of one or more items to the user U-2, for example. At that time, the second receiver 113 may present one or more items arranged in descending order of importance calculated by the classifier 112. The second receiver 113 may present, for example, only a predetermined number of items, in descending order of importance to the user U.

At the time of voting, for example, a remedy idea for each item, which has been acquired by the classifier 112 from an Al engine, or a remedy idea for each item, which has been presented by the user U-1 together with a complaint or the like, may be presented to the user U-2 together with the item. Items alone may be presented to the user U-2 without the corresponding remedy ideas.

The second receiver 113 receives, for example, a vote (hereinafter, referred to as “improvement necessary vote”) on items for which the user U-2 considers that an improvement is required among the presented items. Alternatively, the second receiver 113 may receive, for example, a vote (hereinafter, referred to as “improvement unnecessary vote”) on items for which the user U-2 considers that an improvement is not required. The second receiver 113 may receive, for example, both the improvement necessary vote and the improvement unnecessary vote.

The calculator 114 multiplies the vote by a coefficient corresponding to points held by the user U-2, to calculate a vote count score of each of the one or more items. In other words, the calculator 114 multiplies the vote by a coefficient corresponding to points held by each of the users U participating in the voting, to calculate a vote count score of each of the one or more items.

In the present embodiment, each of the users U-1 to U-N holds points. These points are granted by the point allocator 116, which will be described later. In a case in which a remedy for improving the virtual space access service is implemented, the point allocator 116 grants points to a user (hereinafter, referred to as “proposing user”) who has expressed a complaint or the like serving as a trigger for the remedy, details of which will be described later.

The calculator 114 multiplies, for example, the vote of a user U holding more points by a larger coefficient to calculate the vote count score. Specifically, for example, the calculator 114 multiplies the vote of a user U holding zero point by a coefficient of 1, multiplies the vote of a user U holding one point by a coefficient of 2, and multiplies the vote of a user U holding two points by a coefficient of 3. In this case, the vote count score of the vote of a user U holding zero points is 1, and the vote count score of the vote of a user U holding two points is 3. Generally, an item having a larger vote count score is improved preferentially. Accordingly, with the calculation of the vote count score using a coefficient corresponding to points held by each user U, the impact of the vote of a user U holding more points for a result becomes greater.

The presenter 115 presents the vote count score of each of one or more items, which is calculated by the calculator 114, to at least one of the administrator of the virtual space access service or the users U-1 to U-N using the virtual space access service. Generally, the administrator of a service implements a remedy for improving the service. Therefore, in this case, the vote count scores are presented only to the administrator. The administrator selects an item to be addressed preferentially in view of the presented vote count scores and implements a remedy for improving the selected item.

In a case in which the virtual space access service is operated by a DAO (Decentralized Autonomous Organization), the users U-1 to U-N using the virtual space access service also voluntarily participate in improving the service. Therefore, in this case, the vote count scores are presented to the users U-1 to U-N. The users U-1 to U-N select an item to be addressed preferentially in view of the presented vote count scores and implement a remedy for improving the item. Alternatively, the vote count scores may be presented to both the users U-1 to U-N and the administrator of the virtual space access service.

The point allocator 116 grants points to the user U-1 in a case in which a remedy for an improvement has been implemented for one or more items corresponding to a complaint or a request received from the user U-1. In other words, in a case in which a remedy for improving the virtual space access service is implemented, the point allocator 116 grants points to a user (hereinafter, referred to also as “proposing user”) that has expressed a complaint or the like that served as a trigger for implementation of the remedy. For example, in a case in which a remedy for improving the “algorithm for matching personal elements such as preferences or a character of a user U with a community” described above has been implemented, points are granted to the user U-1 that has expressed a complaint corresponding to this item. Similarly, points are granted also to the user U-3 that has expressed a complaint corresponding to this item.

As to whether to implement a remedy on each of the one or more items is determined, for example, by the administrator of the service. Alternatively, as to whether to implement a remedy may be determined by at least one of the users U-1 to U-N using the service. The contents of the remedy may be, for example, the contents of a remedy idea for the associated item acquired by the classifier 112 from an AI engine, or the contents of a remedy idea for the associated item presented by the user U-1 together with a complaint or the like.

Points are granted to the proposing user because a complaint or the like expressed by the proposing user is determined to be more useful than other complaints or the like. By granting points to the proposing user, the influence of the proposing user on the voting is increased, so that an improvement to the virtual space access service can be performed more efficiently.

In a case in which the first receiver 111 receives a remedy idea for a complaint or the like from the user U-1 together with the complaint or the like, the point allocator 116 may increase points to be granted to the user U-1 as compared to a case in which the complaint or the like alone is received. For example, it is also possible that the point allocator 116 grants one point to the user in a case in which only a complaint or the like is received, and three points in a case in which a complaint or the like and a remedy idea are received. This motivates the user U-1 to make useful remarks that are likely to lead to an improvement of the service.

### A-5. Operation of Processing Apparatus 103

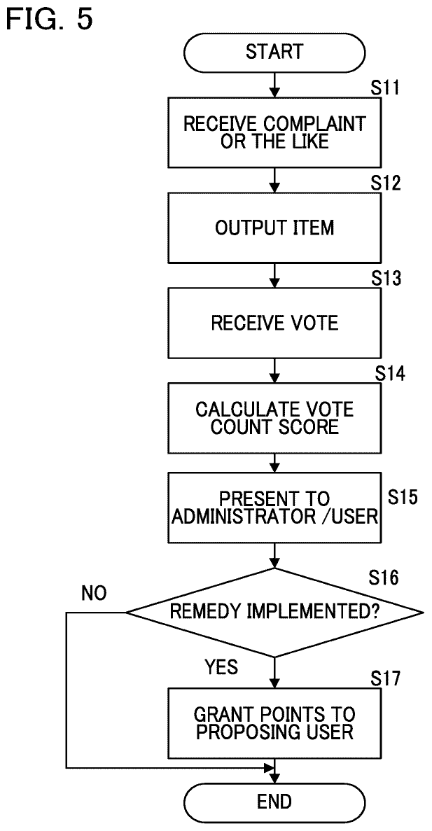

FIG. 5 is a flowchart illustrating an operation of the processing apparatus 103. The processing apparatus 103 of the server 10 functions as the first receiver 111 to receive a complaint or the like from the user U-1 (Step S11). The processing apparatus 103 functions as the classifier 112 to classify the complaint or the like received at Step S11 and output one or more items (Step S12).

The processing apparatus 103 functions as the second receiver 113 to receive, from the user U-2, a vote for determining whether an improvement is required regarding a part or all of the one or more items (Step S13). The processing apparatus 103 functions as the calculator 114 to calculate a vote count score by multiplying the vote received at Step S13 by a coefficient corresponding to points held by the user U-2 (Step S14). The processing apparatus 103 functions as the presenter 115 to present the vote count score for each item calculated at Step S114 to at least one of the administrator of the service or the users U-1 to U-N (Step S15).

The processing apparatus 103 determines whether a remedy for an improvement has been implemented with respect to one or more items corresponding to the complaint or the like received from the user U-1 (Step S16). In a case in which a remedy has been implemented (Step S16: YES), the processing apparatus 103 functions as the point allocator 116 to grant points to the user U-1 (the proposing user) that has expressed the complaint or the like corresponding to an item to which the remedy has been implemented (Step S17), and ends the processing of the present flowchart. In a case in which no remedy has been implemented (Step S16: NO), the processing apparatus 103 ends the processing of the present flowchart without granting points to the user U-1 (the proposing user).

### A-6. Summary of Embodiment

As described above, the server 10 according to the embodiment receives a complaint or the like regarding a virtual space access service from the user U-1 who uses the service. A complaint or the like is received at the server in both a case in which the user U-1 consciously expresses a complaint or the like and a case in a case in which the user U-1 subconsciously expresses a complaint or the like. Therefore, a complaint or the like of the user U-1 can be collected automatically, and the cost can be reduced, for example, as compared to a case in which operators receive complaints or the like. By receiving a complaint or the like expressed subconsciously by the user U-1, it is possible to receive an opinion of the user U-1, for example, even in a case in which the user U-1 does not voluntarily express a complaint or the like. Accordingly, various opinions of the users U can be reflected in the service.

The server 10 receives a vote from the user U-2 on one or more items output by classifying a complaint or the like. The user U-2 can be aware that the user is participating in an improvement to the service by voting on items that are based on a complaint or the like of the user. Therefore, it is possible to provide the user U-2 with a positive idea that the user can proactively improve the service, rather than merely using the service in a passive manner.

The server 10 calculates a vote count score of each of one or more items by multiplying the vote by a coefficient corresponding to points held by the user U-2. As will be described later, it can be said that remarks made by the user U-2 are useful in a case in which the user U-2 holds many points. By calculation of the vote count score using points, the influence of the user U-2 making useful remarks on the vote result can be increased and an improvement to the service can be performed efficiently.

The server 10 grants points to a proposing user that has expressed a complaint or the like corresponding to an item to which a remedy for an improvement has been implemented. As described above, the vote count score corresponding to the vote is determined by points held by each user U. Therefore, the influence of a user U making useful remarks on the vote result (the vote count score) can be increased and an improvement to the service can be performed efficiently.

### B: Modifications

Modified modes in the embodiment described above are illustrated below. Two or more modes optionally selected from the following modified modes may be combined with one another as appropriate within a range in which there is no conflict.

### B1: First Modification

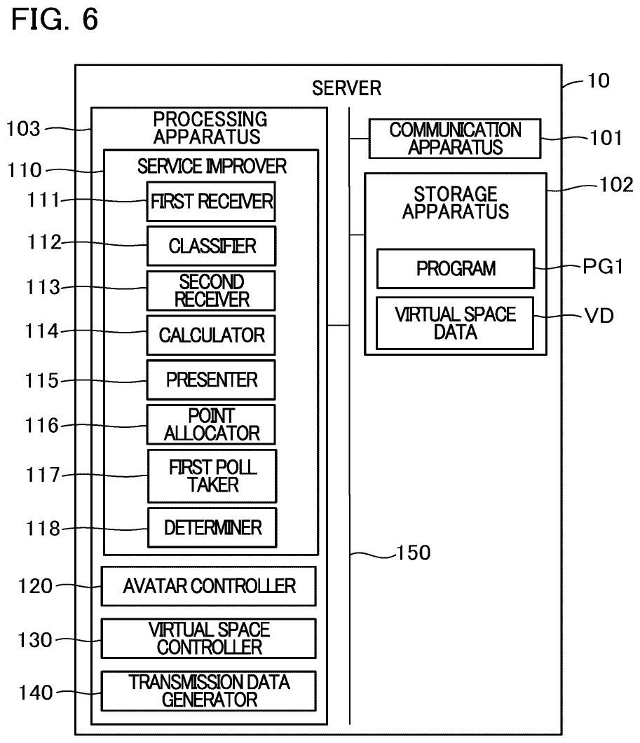

FIG. 6 is a block diagram illustrating a configuration of the server 10 according to a first modification. The server 10 according to the first modification includes a first poll taker 117 and a determiner 118 in addition to the configuration of the server 10 according to the embodiment.

The first poll taker 117 presents one or more items output by the classifier 112 to each of the users U-1 to U-N using the virtual space access service, and receives a response indicating whether the user desires an improvement for each of one or more items. All users U using the virtual space access service may respond to a poll conducted by the first poll taker 117, or a part of users U selected according to a predetermined criterion (for example, users U holding a predetermined number of points or more) may respond thereto.

The determiner 118 determines a target item for voting, from among one or more items, based on the responses to the poll. Specifically, the determiner 118 determines items for which relatively many users U have responded that the user desires an improvement among the one or more items, as target items for voting.

There is a possibility that a huge number of items are output from the classifier 112 depending on the number of users U using the virtual space access service. In a case in which the number of items determined as voting targets is too large in receiving votes from the users U at the second receiver 113, there is a possibility that the users U find voting burdensome or that the votes are so scattered that an appropriate vote result is not obtained. Therefore, in the first modification, target items for voting are narrowed from the one or more items output from the classifier 112 on the basis of the poll. This facilitates each of the users U to, for example, search for an item matching a complaint felt by the user or scan through all the items, and the users U can vote more easily as compared to a case in which all items are listed.

According to the first modification, an appropriate number of items can be presented as targets for voting to the users U and the effectiveness of the voting can be enhanced.

### B2: Second Modification

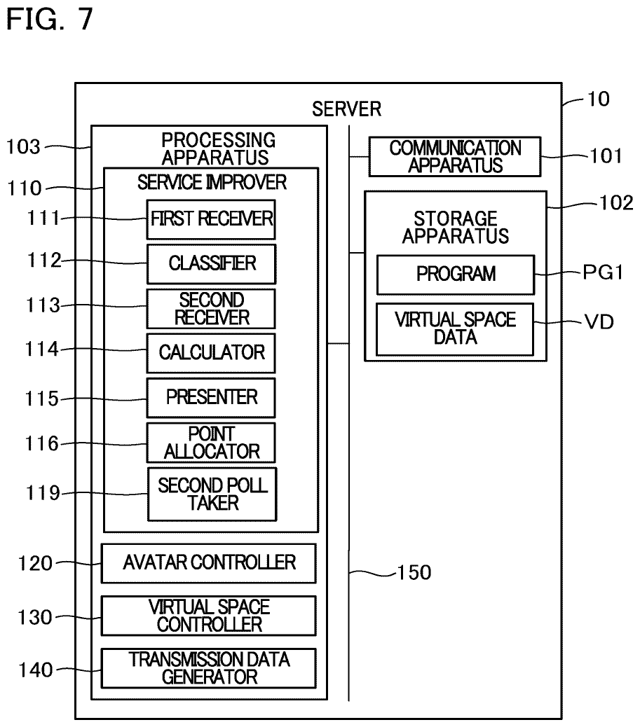

FIG. 7 is a block diagram illustrating a configuration of the server 10 according to a second modification. The server 10 according to the second modification includes a second poll taker 119 in addition to the configuration of the server 10 according to the embodiment.

The second poll taker 119 conducts a poll after a remedy for an improvement is implemented to a predetermined item and before granting of points by the point allocator 116 is performed. Targets for the poll are users U that have cast a vote requesting an improvement of an item (the predetermined item described above) to which a remedy for an improvement has been implemented. The content of the poll is whether the user perceives an effect of the remedy for an improvement. That is, the second poll taker 119 receives, from each of the users U that have cast an improvement necessary vote on an item to which the remedy for an improvement has been implemented, a response indicating whether the user perceives an effect of the remedy for an improvement.

In the second modification, in a case in which the ratio of users U that have responded to the second poll taker 119 that the users perceive the effect of the remedy is equal to or greater than a predetermined ratio, the point allocator 116 grants points to the user U-1 (the proposing user). That is, in a case in which many users U actually experience an improvement of the service as a result of the implemented remedy, points are granted to the user U-1. In other words, points are granted to a proposing user that has made useful remarks actually leading to an improvement of the service. As a result, the influence of the proposing user that has made useful remarks on voting is increased and an improvement to the service can be performed more efficiently.

Alternatively, in a case in which the ratio of users U having responded to the second poll taker 119 that the users perceive the effect of the remedy is equal to or greater than a predetermined ratio, the point allocator 116 may increase points to be given to the user U-1 as compared to a case in which the ratio of users U having responded that the users perceive the effect of the remedy to be less than the predetermined level. That is, in a case in which many users U actually experience an improvement to the service as a result of the implemented remedy, points to be given to the user U-1 may be increased.

### B3: Third Modification

In the embodiment described above, a case in which points are granted to the user U-1 has been described. The points given to the user U-1 are aggregated. However, the points may be reduced in a predetermined case. Specifically, for example, a third poll taker is provided that receives, from the users U using the virtual space access service, responses indicating whether the users perceive that the service has become harder to use as a result of a remedy for a predetermined item. Targets for the poll conducted by the third poll taker may be all the users U-1 to U-N using the service, or may be users U that have cast an improvement necessary vote on the predetermined item. In a case in which the ratio of users U having responded to the third poll taker that the users perceive the service has become harder to use as a result of the implemented remedy is equal to or greater than a predetermined level, the point allocator 116 reduces points of a proposing user of the remedy.

Alternatively, for example, in a case in which a user U expresses a complaint or the like or a remedy idea that is detrimental to a specific user U, or in a case in which a user U expresses a complaint or the like or a remedy idea that degrades the quality of the entire service, the point allocator 116 may reduce the points. This can decrease the influence on voting of a user U presenting an inappropriate proposal. It is also possible that each user U not be informed of the user's points.

### B4: Fourth Modification

In the embodiment described above, the virtual space access service has been described as the service provided by the system 1. However, the service provided by the system 1 is not limited to the virtual space access service and may be other services. Examples of the other services are a service using the network NET or a service operated by a DAO.

According to the fourth modification, the system 1 according to the present embodiment is applicable to various services.

### C: Other Matters

(1) In the foregoing embodiment, a ROM and a RAM, etc., are given as examples of the storage apparatus 102 and the storage apparatus 205. However, the storage apparatus 102 and the storage apparatus 205 each may be configured with a flexible disc, a magneto-optical disc (e.g., a compact disc, a digital versatile disc, a Blu-ray (registered trademark) disc), a smart card, a flash memory device (e.g., a card, a stick, a key drive), a compact disc ROM (CD-ROM), a register, a removable disk, a hard disk, a floppy (registered trademark) disc, a magnetic strip, a database, a server, or any other appropriate recording medium.

(2) The information, the signals, or the like described in the foregoing embodiments may be represented using any of a variety of different technologies. For example, data, instructions, commands, information, signals, bits, symbols, chips, or the like that may be mentioned throughout the foregoing description may be represented by a voltage, a current, an electromagnetic wave, a magnetic field, a magnetic particle, an optical field, a photon, or a given combination thereof.

(3) In the foregoing embodiment, for example, input or output information may be stored in a specific location (e.g., a memory) or may be managed using a management table. For example, information to be input or output may be overwritten, updated, or additionally written. For example, the output information may be deleted. For example, the input information may be transmitted to another apparatus.

(4) In the foregoing embodiment, a determination may be made based on a value (0 or 1) represented by one bit, may be made based on a true or false value (Boolean), or may be made based on a comparison between numerical values (e.g., a comparison with a predetermined value).

(5) With regard to the processing procedures, sequences, flowcharts, or the like exemplified in the foregoing embodiment, the order may be changed unless a conflict arises. For example, the methods described in the present disclosure present various step elements in an exemplary order; however, the methods are not limited to the specific presented order.

(6) Each function illustrated in FIG. 2 or 3 is implemented by a given combination of at least one of hardware and software. The method of implementing each functional block is not particularly limited. Each functional block may be implemented using a physically or logically coupled single device or may be implemented using two or more devices that are physically or logically separated from each other, by connecting the two or more devices directly or indirectly (e.g., in a wired manner or a wireless manner). Each function may be implemented by a combination of the single device or the two or more devices with software.

(7) The programs exemplified in the foregoing embodiment should be broadly construed to involve an instruction, an instruction set, a code, a code segment, a program code, a program, a subprogram, a software module, an application, a software application, a software package, a routine, a subroutine, an object, an executable file, an execution thread, a procedure, a function, or the like, regardless of whether the programs are each called software, firmware, middleware, microcode, hardware description language, or by another name.

For example, software or a command may be transmitted and received via a transmission medium. For example, in a case in which software is transmitted from a website, a server, or another remote source, using at least one of a wired technique (e.g., a coaxial cable, a fiber optic cable, a twisted pair cable, a digital subscriber line (DSL)) and a wireless technique (e.g., an infrared ray, a microwave), at least one of the wired technique and the wireless technique is included within the definition of the transmission medium.

(8) In each of the foregoing embodiments, the term “system” and “network” may be interchangeably used.

(9) The information, the parameter, or the like described in the present disclosure may be expressed by using an absolute value, may be expressed by using a value relative to a predetermined value, or may be expressed by using other corresponding information.

(10) In the foregoing embodiment, a portable device may be a mobile station (MS). The mobile station may be called a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or another suitable term by one skilled in the art. In the present disclosure, the terms “mobile station”, “user terminal”, “user equipment (UE)”, “terminal”, and the like can be compatibly used.

(11) In the foregoing embodiment, the term “connected”, “coupled”, or other given transformations thereof can refer to any direct or indirect connection or coupling between two or more elements, and can involve the presence of one or more intermediate elements between two elements that are “connected” or “coupled” together. A coupling or connection between elements may be a physical coupling or connection, may be a logical coupling or connection, or may be a combination thereof. For example, the term “connection” may be understood as “access”. It can be appreciated in the present disclosure that two elements are “connected” or “coupled” together using at least one of one or more electric wires, one or more cables, and one or more printed electrical connections and using, as some non-limiting and non-comprehensive examples, electromagnetic energy at wavelengths in a radio frequency range, a microwave range, and an optical (both visible and invisible) range.

(12) In the foregoing embodiment, the phrase “based on” does not involve “based only on” unless otherwise specified. In other words, the phrase “based on” involves both “based only on” and “based at least on”.

(13) The term “determining” used in the present disclosure includes a variety of operations in some cases. For example, the term “determining” may involve “judging”, “calculating”, “computing”, “processing”, “deriving”, “investigating” “looking up, searching for, making an inquiry) (e.g., searching a table, a database, or another data structure), and “ascertaining” to be regarded as “determining”. The term “determining” may involve “receiving” (e.g., receiving information), “transmitting” (for example, transmitting information), “input”, “output”, or “accessing” (e.g., accessing data in a memory) to be regarded as “determining”. The term “determining” may involve “resolving”, “selecting”, “choosing”, “establishing”, or “comparing” to be regarded as “determining”. That is, the term “determining” may involve a given sort of action to be regarded as “determining”. For example, the term “determining” may be understood as “assuming”, “expecting”, “considering”, or the like.

(14) In the foregoing embodiment, the terms “include” and “including” as well as transformations thereof are intended to be open-ended as in the term “comprising” in a case in which these terms are used. In addition, the term “or” as used in the present disclosure is not intended to be an exclusive OR.

(15) Throughout the present disclosure, for example, a singular feature preceded with an article such as “a”, “an”, or “the” in the English translation may be understood as including plural features.

(16) In the present disclosure, the description “A and B are different” may mean “A and B are different from each other”. The description may mean “each of A and B is different from C”. The terms “separated”, “coupled”, and the like may be construed in substantially the same manner as “different”.

(17) Respective aspects and embodiments described in the present disclosure may be used individually, may be combined and used, or may be switched and used according to execution. A report of predetermined information (for example, a report of “X”) is not limited to a report that is explicitly made, and may be implicitly made (for example, without making a report of the predetermined information).

In addition, multiple aspects exemplified in the present specification may be combined.

### Description of Reference Signs

1 . . . system, 10 . . . server, 20(20-1~20-N) . . . user terminal, 110 . . . service improver, 111 . . . first receiver, 112 . . . classifier, 113 . . . second receiver, 114 . . . calculator, 115 . . . presenter, 116 . . . point allocator, 117 . . . first poll taker, 118 . . . determiner, 119 . . . second poll taker, A(A-1~A-N) . . . avatar, NET . . . network, U(U-1~U-N) . . . user, VS . . . virtual space.

1. A service provision apparatus comprising:
a first receiver configured to receive from a first user a complaint or a request regarding a service;
a classifier configured to classify the complaint or the request received by the first receiver, to output one or more items related to an improvement to the service;
a second receiver configured to, for a part or all of the one or more items, receive from a second user a vote for determining whether an improvement is required;
a calculator configured to calculate a vote count score for each of the one or more items by multiplying the vote by a coefficient corresponding to points held by the second user,
a presenter configured to present the vote count score for each of the one or more items calculated by the calculator, to at least one of an administrator of the service or users using the service; and
a point allocator configured to grant points to the first user in a case in which a remedy for an improvement has been implemented on the one or more items corresponding to the complaint or the request received from the first user.

2. The service provision apparatus according to claim 1, further comprising:
a first poll taker configured to present the one or more items output by the classifier to the users using the service, to receive a response indicating whether each of the users using the service desires an improvement to each of the one or more items, and
a determiner configured to determine, from among the one or more items, a target item for the vote based on the response.

3. The service provision apparatus according to claim 1, further comprising a second poll taker configured to, for an item to which the remedy has been implemented, receive, from a user having cast a vote indicating that an improvement is required for the item, a response indicating whether the user having cast the vote perceives an effect of the remedy,
wherein the point allocator is configured to grant the points to the first user in a case in which a ratio of users who responded to the second poll taker that the users perceive the effect of the remedy is equal to or higher than a predetermined ratio.

4. The service provision apparatus according to claim 1, wherein:
the first receiver is configured to receive an idea for the remedy for addressing the complaint or the request, together with the complaint or the request, and
the point allocator is configured to increase the points to be granted to the first user in a case in which the first receiver receives an idea for the remedy from the first user together with the complaint or the request, as compared to a case in which the complaint or the request alone is received.

5. The service provision apparatus according to claim 1, wherein the service is a virtual space access service providing an access to a virtual space using a user terminal.

6. The service provision apparatus according to claim 5, wherein the first receiver is configured to receive the complaint or the request, based on an operation, performed on a virtual object corresponding to the complaint or the request by the first user who has accessed the virtual space.
